(19) United States
(12) Patent Application Publication
(10) Pub. No.: US 2002/0147587 A1
(43) Pub. Date: Oct. 10, 2002

(54) System for measuring intelligibility of spoken language

(75) Inventors: Brent Townshend, Menlo Park, CA (US); Jared Bernstein, Palo Alto, CA (US)

Correspondence Address: Matthew J. Sampson, McDonnell Boehnen Hulbert & Berghoff, 32nd Floor, 300 S. Wacker Drive, Chicago, IL, 60606, US

(73) Assignee: Ordinate Corporation, Menlo Park, CA

(21) Appl. No.: 10/087,651

(22) Filed: Mar. 1, 2002

Related U.S. Application Data
(60) Provisional application No. 60/272,564, filed on Mar. 1, 2001.

(51) Int. Cl. G10L 15/26

(52) U.S. Cl. 704/235

(57) ABSTRACT

An intelligibility measuring system provides a system and method of evaluating intelligibility of a speaker. Intelligibility may be a function of the speaker's pronunciation of words, material being spoken, context in which words are spoken, and skill of a listener. The speaker repeats items. The items may be words or combination of words. The listener hears the speaker articulating items and a transcription is created to document what the listener heard. A measurement unit determines an error count based on a comparison of the items and the transcription. An intelligibility score is then determined using the error count, difficulty level of the items, and ability of the listener.

### RELATED APPLICATION

This application claims priority to and incorporates by reference U.S. Provisional Application Serial No. 60/272,564 filed Mar. 1, 2001.

### FIELD

The present invention relates generally to measuring a person's speaking ability, and more particularly, relates to measuring intelligibility of spoken language.

### BACKGROUND

Intelligibility may be defined as the degree to which others can understand a person's speech. There are many reasons why a person's speech may be unintelligible. One factor may be the type of equipment being used to transmit speech. For example, a poor quality phone, answering machine, or public address system may impact the quality of the voice transmission causing a person's speech to be difficult to understand. Another factor may be the location of the person while speaking. For example, if the person is in a noisy room or underwater it may be difficult for someone to understand what that person is saying. Another factor may be the listener's ability to hear. If the listener has a hearing loss, they may not understand what another person is saying. The American National Standards Institute (ANSI) has developed standards for measuring intelligibility with respect to communication systems, such as S3.2-1989 “Method for measuring the intelligibility of speech over communication systems” and S3.5-1997 “Methods for calculation of the speech intelligibility index.”

Another reason why a person may be unintelligible is the person's ability to speak. For one reason or another, when the person speaks, it is difficult to understand them. The difficulty may be a result of a speech impairment, unfamiliarity with the language, age, or other reasons.

There are many instances in which an objective score of a person's intelligibility may be important. For example an employer may be searching for a job candidate whose ability to be understood by others may be important to the position. The position may require the employee to give instructions or provide information to other employees, customers, or students. The employer may be hiring customer service representatives, teachers, or emergency response coordinators.

Human evaluators may be used to judge a person's intelligibility; however, human evaluators may be subjective. The skill of the human evaluator may be a factor in the evaluation. In addition, two different human evaluators may use a different scale to judge a person's intelligibility. The scales may use descriptive terms, such as easy and difficult, to describe how understandable the person's spoken language is. The scores provided by a human evaluator may have no inherent meaning and may only represent what that particular human evaluator thought at that particular time.

Therefore, it would be desirable to provide an objective measure of an individual's intelligibility. With an objective measure of intelligibility a decision may be made using reliable data.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 illustrates a simplified block diagram of an intelligibility measurement system, according to a first embodiment;

FIG. 2 illustrates a simplified block diagram of an intelligibility measurement system, according to another embodiment;

FIG. 3 is a simplified flow diagram of an intelligibility measurement method, according to a first embodiment;

FIG. 4 is a simplified flow diagram of an intelligibility measurement method, according to another embodiment;

FIG. 5 illustrates a simplified block diagram of an automated intelligibility measurement system, according to an embodiment;

FIG. 6 illustrates a simplified flow diagram of Step 1 of an intelligibility measurement method, according to another embodiment;

FIG. 7 illustrates a simplified flow diagram of Step 2 of an intelligibility measurement method, according to another embodiment;

FIG. 8 illustrates a simplified flow diagram of Step 3 of an intelligibility measurement method, according to another embodiment; and

FIG. 9 illustrates a simplified flow diagram of Step 4 of an intelligibility measurement method, according to another embodiment.

### DETAILED DESCRIPTION

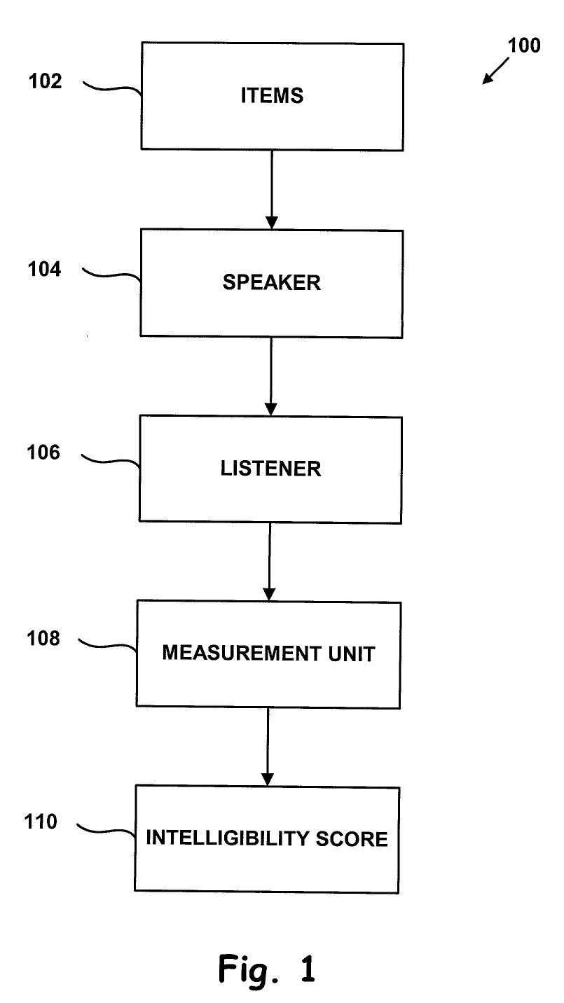

FIG. 1 shows a simplified block diagram of an intelligibility measurement system 100. The intelligibility measurement system 100 includes items 102, a speaker 104, a listener 106, and a measurement unit 108. An output of the intelligibility measurement system 100 may include an intelligibility score 110. The items 102 may be words or a combination of words. For example, the items 102 may be a number of sentences of varying lengths and complexity.

The speaker 104 may be at least one person whose intelligibility is to be measured. Preferably, a plurality of speakers 104 may be evaluated by the intelligibility measurement system 100 at substantially the same time. The intelligibility of the speaker 104 may be a degree to which spoken language of the speaker 104 may be understood. Intelligibility may be a function of the speaker's pronunciation of words, material being spoken, context in which words are spoken, and skill of the listener 106.

For example, the speaker 104 may be a person applying for admission to an academic institution or for a job. The academic institution or the potential employer may desire an objective measure of the speaker's intelligibility as a factor in determining whether or not to admit or hire the speaker 104. The position may require that the person possess speaking abilities such that others may understand him or her while speaking. While academic admissions and employee hiring are provided as two examples, there may be other situations in which an objective measure of the speaker's intelligibility would be desirable.

To be evaluated for intelligibility, the speaker 104 may be asked to repeat items 102. The items 102 may be selected randomly or for a specific purpose, such as a specific academic position. The items 102 may be recorded and a recording of the items may be played to the speaker 104 for repeating. Alternatively, the items 102 may be presented directly to the speaker 104 in a written or verbal format. As the speaker 104 repeats the items 102, the speaker's responses may be recorded. A recording of the responses may be provided to the listener 106. Alternatively, the listener 106 may hear the speaker's responses as the speaker 104 repeats the items 102.

The speaker's responses may be evaluated to determine whether or not the speaker 104 correctly repeated the item 102. For example, if the speaker 104 skipped a word in the items 102, that response may not be evaluated for intelligibility.

The listener 106 may be at least one person capable of listening. The listener 106 may hear the speaker's responses, either directly from the speaker 104 or from the recording of the responses. The speaker 104, the measurement unit 108, or another source may provide the recording of the responses to the listener 106. Preferably, a plurality of listeners 106 may be used by the intelligibility measurement system 100 at substantially the same time. The listener 106 may not have any language evaluation training prior to hearing the speaker's responses. Furthermore, the listener 106 may not know what items 102 the speaker 104 will be repeating prior to hearing the speaker's responses. Alternatively, the listener 106 may be selected based on certain characteristics, such as having a specific demographic, language, technical or academic background.

Upon hearing the speaker's responses, the listener 106 may repeat or transcribe the responses. If the listener 106 repeats the responses, the listener 106 may be recorded. The recording of the listener 106 may then be transcribed. A transcription may be a written copy of what the listener 106 heard when listening to the speaker's responses. The transcription may be created by a person or by an automatic speech recognition (ASR) transcription program. The transcription may then be provided to the measurement unit 108. Alternatively, the listener 106 may be capable of repeating the speaker's responses directly to the measurement unit 108.

The measurement unit 108 may be any device operable to compare the transcription with the items 102 and produce the intelligibility score 110. The measurement unit 108 may include any combination of hardware, software, and/or firmware. For example, the measurement unit 108 may be a computer that is loaded with software that causes the measurement unit 108 to automatically generate the intelligibility score 110 based upon the transcription. Alternatively, the measurement unit 108 may include a person capable of comparing the transcription with the items and/or objectively determining the intelligibility score 110.

The measurement unit 108 may determine an error count by comparing how closely the transcription matches the items 102. The error count may be a measure of how well the listener 106 was able to understand the speaker's responses. For example, the error count may be determined by evaluating the number of word insertions, deletions, and substitutions in the transcription as compared to the items 102. Other factors may also be used to determine the error count.

The measurement unit 108 may use the error count, a difficulty level of the items 102, and an ability of the listener 106 to determine the intelligibility score 110 for the speaker 104. Other factors may also be used in determining the intelligibility score 110. The intelligibility score 110 may provide an objective measure of how understandable the speaker 104 is while speaking. For example, the speaker 104 may receive an intelligibility score of 80%. The intelligibility score of 80% may represent that 80% of the speaker's spoken language is understandable to a listener who is not familiar with the speaker 104 or the items 102.

The measurement unit 108 may use Item Response Theory (IRT) to determine the intelligibility score 110. IRT is a statistical analysis method that is well known in the art, and in this example, may be employed to decompose the differences between the items 102 and the transcription into linear effects due to difficulty of the items 102, intelligibility of the speaker 104, and ability of the listener 106. For example, Facets, a commercially available software program available from Mesa Press, may be included as part of the measurement unit 108. However, other statistical analysis methods and related software products may alternatively be employed.

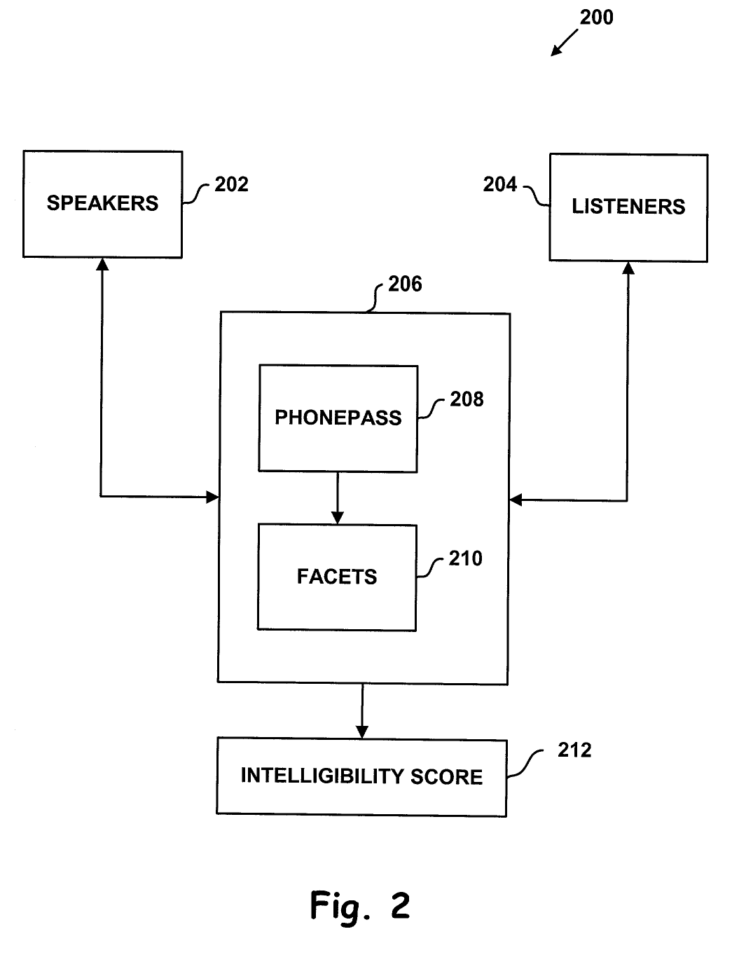

FIG. 2 illustrates a simplified block diagram of an intelligibility measurement system 200. The intelligibility measurement system 200 may include speakers 202, listeners 204, and a measurement unit 206. The speakers 202 and the listeners 204 may be substantially the same as the speaker 104 and the listener 106 of the intelligibility measuring system 100, respectively.

The measurement unit 206 may include a speech recognition system 208 and IRT software 210, as well as other components. The speech recognition system 208 may be PhonePass, which is a system owned by Ordinate Corporation and is typically used to test a person's facility in spoken English. The IRT software 210 may be Facets software. Other speech recognition systems and IRT software may also be used. An output of the measurement unit 206 may be an intelligibility score 212.

The speakers 202 may be asked to repeat items and the speakers' responses may be recorded. A recording of the speakers' responses may be stored in the PhonePass system 208. The listeners 204 may access the PhonePass system 208 using the telephone. Alternative methods of accessing the PhonePass system may also be available, such as using Voice over Internet Protocol (VoIP). The recording of the speakers' responses may be played back to the listeners 204 and the listeners 204 may repeat the responses into the PhonePass system 208. The PhonePass system 208 may then determine the differences between the recorded responses of the speakers 202 and the repetition of the listeners 204.

The Facets software 210 may then analyze the differences and provide the intelligibility score 212 for the speakers 202. The Facets software 210 may also provide additional outputs, such as a difficulty score for the items and/or an ability score for the listeners 204. For example, the intelligibility measuring system 200 may be operable to provide an objective ability score for how well the listeners 204 understand other people. There may be a need to identify listeners with an ability to understand people with speaking difficulties. By increasing the number of listeners and/or the number of items, the reliability of the intelligibility score 212 may be improved.

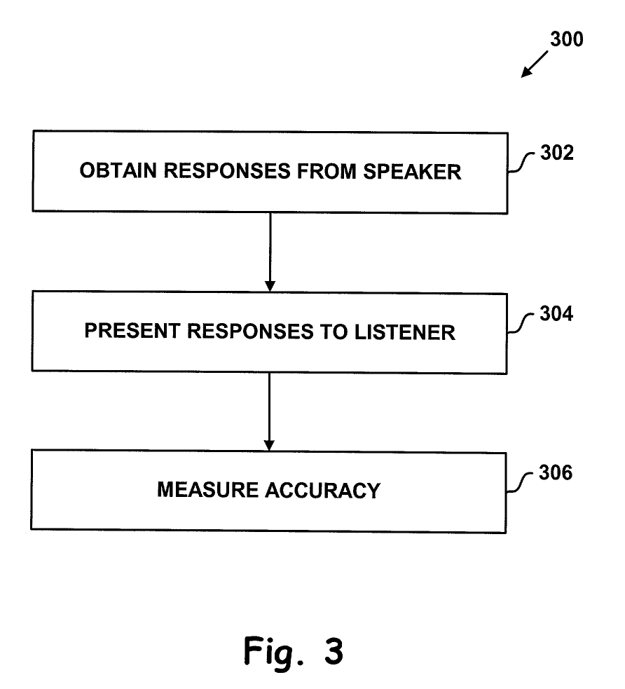

FIG. 3 shows a simplified flow diagram illustrating an intelligibility measuring method 300. While the intelligibility measuring method 300 is shown as having three steps, each step may include sub-steps that are not depicted in FIG. 3.

Step 302 is obtaining responses from a speaker. The speaker may be substantially the same as the speaker 104 of the intelligibility measuring system 100. The speaker may be asked to repeat items. The items may be substantially the same as the items 102 of the intelligibility measuring system 100. The responses may be spoken language of the speaker while repeating items. If the speaker does not repeat the items correctly (e.g. adding or dropping a word), the speaker's response may not be evaluated for intelligibility.

Step 304 is presenting responses to a listener. The listener may be substantially the same as the listener 106 of the intelligibility measuring system 100. The listener may hear the speaker's responses, either directly or by listening to a recording of the speaker's responses. The listener may repeat the responses. A transcription of the listener's repetition of the speaker's responses may be created.

Step 306 is measuring accuracy. A measurement unit may determine an error count that represents how closely the transcription matches the items. The measurement unit may be substantially the same as the measurement unit 108 of the intelligibility measuring system 100. The error count may be a measure of how well the listener was able to understand the spoken language of the speaker. The error count may be determined by evaluating the number of word insertions, deletions, and substitutions in the transcription in comparison to the items.

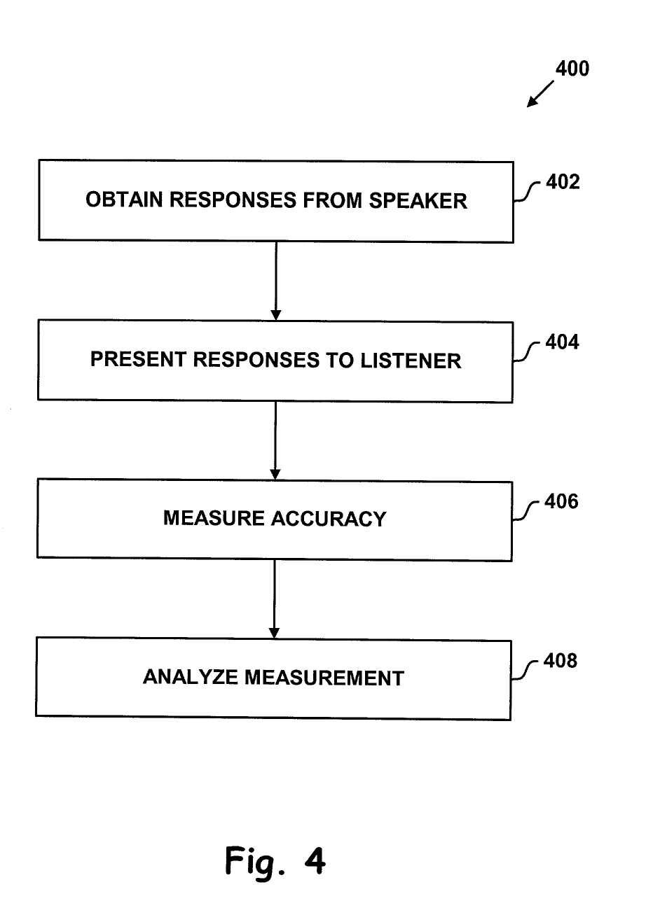

FIG. 4 shows a simplified flow diagram illustrating an intelligibility measuring method 400. The intelligibility measuring method 400 may be substantially the same as same as the intelligibility measuring method 300 with an additional step. Steps 402 to 406 may be substantially the same as steps 302 to 306 of the intelligibility measuring method 300. Step 408 may include sub-steps that are not depicted in FIG. 4.

Step 408 is analyzing the measurement determined in step 406. The measurement unit may use the error count, difficulty level of the items, and ability of the listener to determine an intelligibility score for the speaker. The intelligibility score may be substantially the same as the intelligibility score 110 of the intelligibility measuring system 100. The intelligibility score may provide an objective measure of how understandable the speaker is while speaking. In addition, the measurement unit may be operable to provide a report of the speaker's intelligibility score.

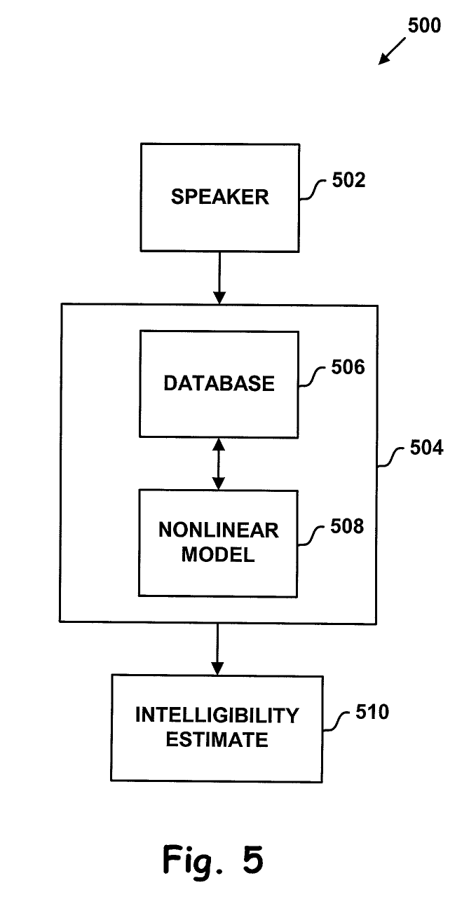

FIG. 5 illustrates a simplified block diagram of an automated intelligibility measurement system 500. The automated intelligibility measurement system 500 may include a speaker 502 and a measurement unit 504. The speaker 502 may be substantially the same as the speaker 104 of the intelligibility measurement system 100. An output of the measurement unit 504 may be an intelligibility estimate 510.

The measuring unit 504 may include a database 506 and a nonlinear model 508. The database 506 may contain substantially all of the speaker responses, items, and listener repetitions from previous evaluations of intelligibility using the intelligibility measurement system 100. The nonlinear model 508 may be a neural network. The database 506 may be used in conjunction with the nonlinear model 508 to determine the intelligibility estimate 510 of the speaker 502 without the use of listeners. The intelligibility estimate 510 may be an estimate of the intelligibility score for the speaker 502 without having to use the listener 106 of intelligibility measurement system 100.

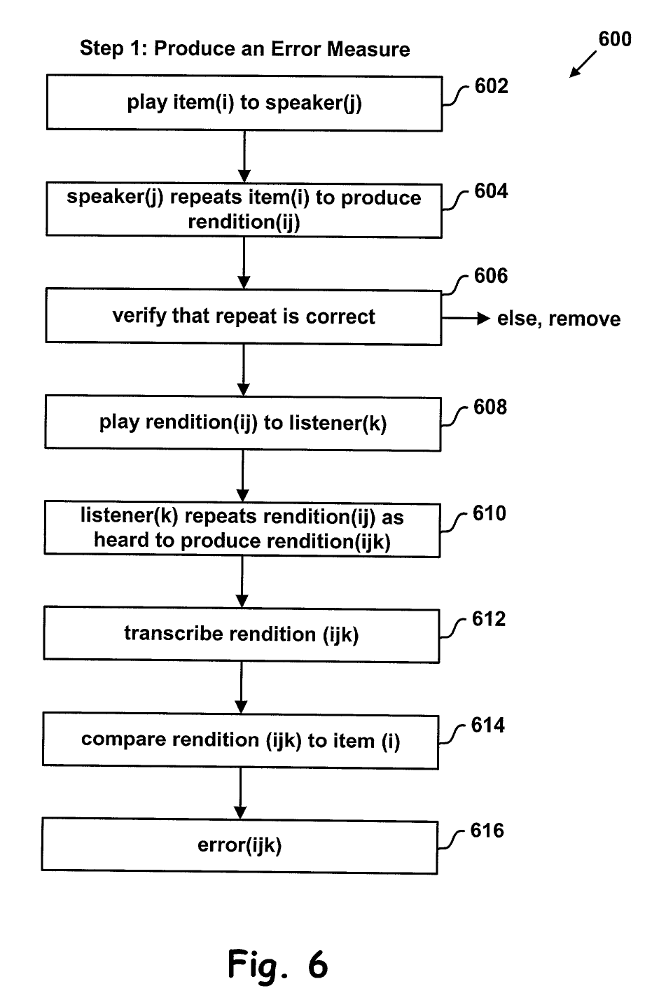

FIGS. 6-9 are simplified flow diagrams of four related methods 600, 700, 800, and 900 for an intelligibility measurement system. Method 600 as shown in FIG. 6 is “Step 1: Produce an Error Measure.” Method 600 is similar to method 300; however, method 600 provides more details. In step 602, item(i) is played to speaker(j). In step 604, speakers) repeats item(i) to produce rendition(ij). In step 606, the intelligibility measuring system verifies that the repeat is correct. If the repeat is not correct, that repetition is removed.

In step 608, the rendition(ij) is played to the listener(k). In step 610, listener(k) repeats the rendition(ij) as heard to produce rendition(ijk). In step 612, rendition(ijk) is transcribed. Rendition(ijk) may be transcribed using ASR or human transcription. Only one method of transcription may be necessary; however, both methods may be used to verify that the ASR transcription is reliable. In step 614, rendition(ijk) is compared to item(i). In step 616, error(ijk) is determined.

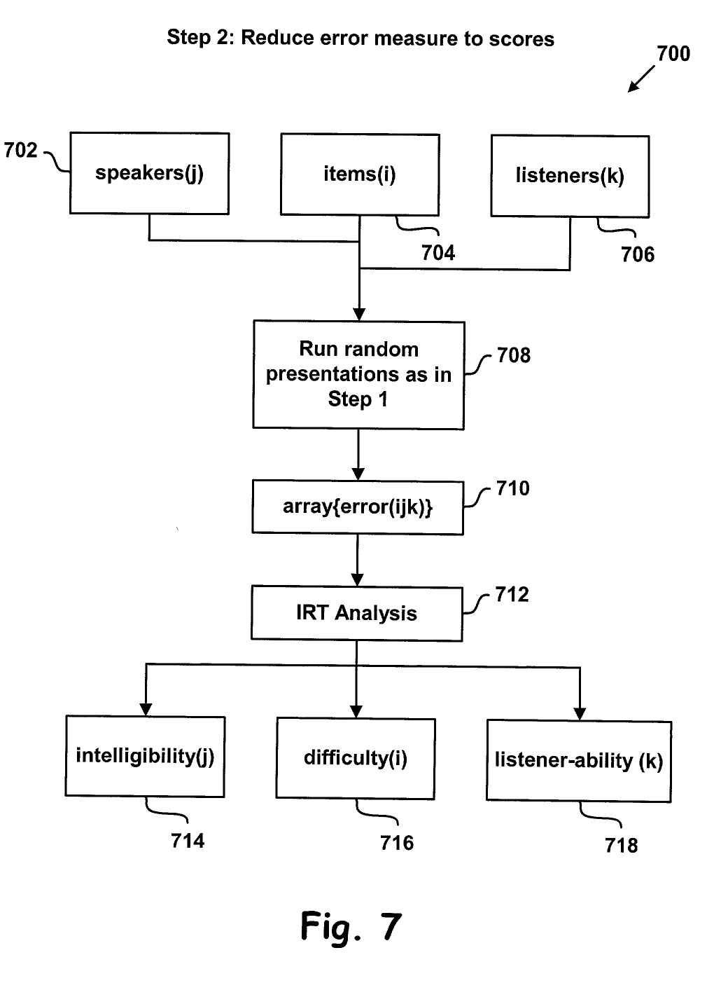

Method 700 as shown in FIG. 7 is “Step 2: Reduce error measure to scores.” Method 700 is similar to method 400; however, method 700 provides more details. Step 708 incorporates the steps of Method 600, using speakers(k) 702, items(i) 704, and listeners(k) 706. The output of step 708 is array{error(ijk)} 710. In step 712, IRT analysis is performed on the output 710. Outputs of the IRT analysis of step 712 include intelligibility(j) 714, difficulty(i) 716, and listener-ability(k) 718.

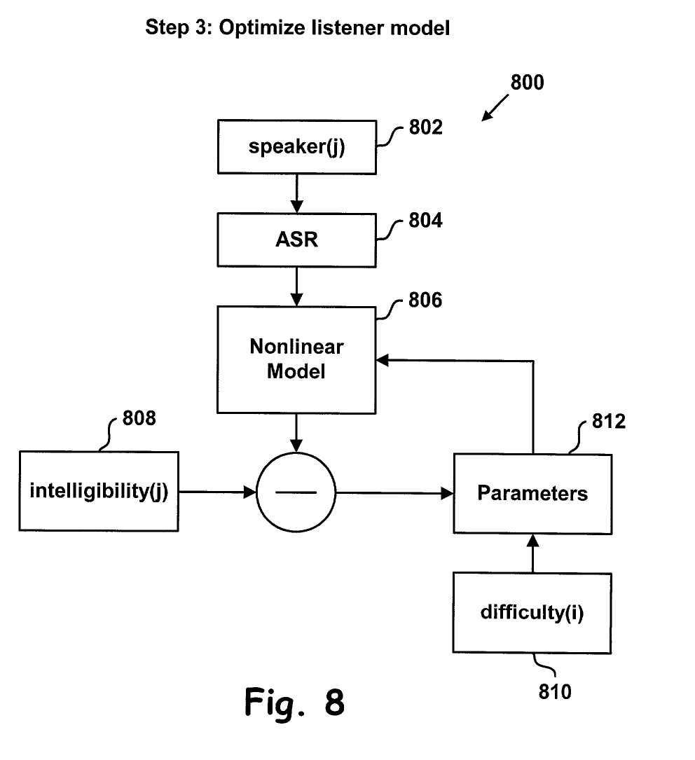

Method 800 as shown in FIG. 8 is “Step 3: Optimize listener model.” Speaker(j) responses 802 are transmitted to an ASR system 804. The output of the ASR system 804 is transmitted to a nonlinear model 806. The nonlinear model 806 is adjusted using intelligibility(j) 808. Intelligibility(j) 808 is substantially the same as intelligibility(j) 714 of method 700. In addition difficulty(i) 810 is one of the parameters 812 that is fed back into the nonlinear model 806. Difficulty(i) 810 is substantially the same as difficulty(i) 716 of method 700.

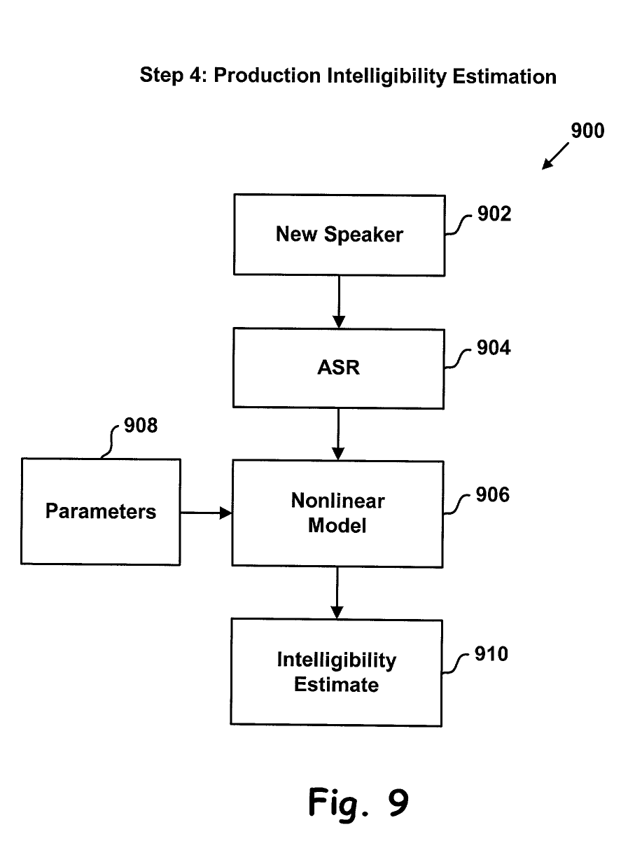

Method 900 as shown in FIG. 9 is “Step 4: Production Intelligibility Estimation. Method 900 begins with a new speaker 902 speaking into an ASR system 904. The output of the ASR system 904 is transmitted to a nonlinear model 906. Parameters 908 are provided to the nonlinear model 906. The parameters 908 may be substantially the same as the parameters 812 of method 800. The nonlinear model 906 may then provide an intelligibility estimate 910. The intelligibility estimate 910 may be substantially the same as the intelligibility estimate 510 of system 500.

By providing an objective measure of an individual's intelligibility, a decision may be made using an intelligibility score that is relatively independent of both the specific items used and the ability of the listener. For example, the intelligibility score may be used in the selection process of a new employee. The employer may use a variety of factors when choosing the best candidate. If the ability to be understood is critical to the performance of the job, the employer may be able to obtain objective intelligibility scores for each of the candidates. In addition, if the employer is planning on hiring a large number of employees, the intelligibility measuring system may be used to measure a large number of applicants at substantially the same time.

It should be understood that the illustrated embodiments are examples only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. An intelligibility measurement system, comprising in combination:
a means for hearing a speaker who is repeating items;
a means for comparing the items with a transcription; and
a means for measuring intelligibility.

2. The system of claim 1, wherein the speaker is at least one person whose intelligibility is to be measured.

3. The system of claim 1, wherein a listener hears the speaker repeating the items.

4. The system of claim 3, wherein the listener is a plurality of people capable of listening.

5. The system of claim 1, wherein the items are words.

6. The system of claim 1, wherein the transcription is a written copy of what a listener heard when the speaker repeated the items.

7. The system of claim 1, wherein an error count is determined by comparing the items with the transcription.

8. The system of claim 7, wherein the error count is determined by evaluating factors selected from the group consisting of word insertions, word deletions, and word substitutions.

9. The system of claim 1, wherein an intelligibility score is determined by evaluating factors selected from the group consisting of error count, difficulty of the items, and ability of a listener.

10. The system of claim 1, wherein Item Response Theory is used to determine an intelligibility score.

11. An intelligibility measurement system, comprising in combination:
a speaker that repeats items;
a listener that hears the speaker repeating the items; and
a measurement unit operable to determine an intelligibility score of the speaker using a transcription of what the listener hears.

12. The system of claim 11, wherein the speaker is at least one person whose intelligibility is to be measured.

13. The system of claim 11, wherein the listener is a plurality of people capable of listening.

14. The system of claim 11, wherein the listener is selected based on certain background characteristics.

15. The system of claim 11, wherein the transcription is a written copy of what the listener heard when the speaker repeated the items.

16. The system of claim 11, wherein the items are words.

17. The system of claim 11, wherein an error count is determined by comparing the items with the transcription.

18. The system of claim 17, wherein the error count is determined by evaluating factors selected from the group consisting of word insertions, word deletions, and word substitutions.

19. The system of claim 11, wherein the intelligibility score is determined by evaluating factors selected from the group consisting of error count, difficulty of the items, and ability of the listener.

20. The system of claim 11, wherein the measurement unit uses Item Response Theory to determine the intelligibility score.

21. An intelligibility measurement system, comprising in combination:
a speaker whose intelligibility is to be measured;
a listener that hears the speaker repeat words; and
a measurement unit operable to determine an intelligibility score of the speaker using a transcription of what the listener hears, wherein the transcription is a written copy of what the listener heard when the speaker repeated the-words, wherein an error count is determined by comparing the words with the transcription, and wherein the measurement unit uses Item Response Theory to determine the intelligibility score.

22. The system of claim 21, wherein the error count is determined by evaluating factors selected from the group consisting of word insertions, word deletions, and word substitutions.

23. The system of claim 21, wherein the intelligibility score is determined by evaluating factors selected from the group consisting of error count, difficulty of the items, and ability of the listener.

24. A method of measuring intelligibility, comprising in combination:
obtaining responses from a speaker;
presenting responses to a listener; and
measuring accuracy.

25. The method of claim 24, further comprising determining an intelligibility score.

26. The method of claim 24, wherein the speaker is at least one person whose intelligibility is to be measured.

27. The method of claim 24, wherein the responses are the speaker's repetition of items.

28. The method of claim 27, wherein the items are words.

29. The method of claim 24, wherein the listener is a plurality of people capable of listening.

30. The method of claim 24, wherein the listener hears the speaker's responses.

31. The method of claim 24, further comprising creating a transcription of what the listener heard.

32. The method of claim 24, further comprising determining an error count by comparing items with a transcription of what the listener heard.

33. The method of claim 32, wherein the error count is determined by evaluating factors selected from the group consisting of word insertions, word deletions, and word substitutions.

34. The method of claim 24, wherein the intelligibility score is determined by evaluating factors selected from the group consisting of error count, difficulty of items, and ability of the listener.

35. The method of claim 24, wherein Item Response Theory is used to determine the intelligibility score.

36. An automated intelligibility measurement system, comprising in combination:
a speaker;
a database; and
a nonlinear model operable to provide an intelligibility estimate.

37. The system of claim 36, wherein the speaker is at least one person whose intelligibility is to be measured.

38. The system of claim 36, wherein the database contains data from previous intelligibility evaluations.

39. The system of claim 38, wherein the database contains data selected from the group consisting of speaker responses, items, and listener repetitions.

40. The system of claim 36, wherein the nonlinear model is a neural network.
